(19) United States
(12) Patent Application Publication
(10) Pub. No.: US 2026/0169801 A1
(43) Pub. Date: Jun. 18, 2026

(54) RESOURCE PREDICTION FOR TENSOR NETWORK SIMULATION

(71) Applicant: Dell Products L.P., Round Rock, TX (US)

(72) Inventors: João Victor da Fonseca Pinto, Rio de Janeiro (BR); Micael Veríssimo de Araújo, Rio de Janeiro (BR); Miguel Paredes Quiñones, Campinas (BR); Rômulo Teixeira de Abreu Pinho, Niterói (BR)

(21) Appl. No.: 18/979,394

(22) Filed: Dec. 12, 2024

(51) Int. Cl. G06F 9/50; G06N 10/20

(52) U.S. Cl. CPC G06F 9/5027; G06N 10/20

(57) ABSTRACT

One example method includes receiving, by an ML (machine learning) model, a quantum circuit, obtaining an importance value of the quantum circuit, for each precision level in a group of precision levels, determining, by the ML model, resources required to run the quantum circuit, and a divergence of the circuit, when the importance value exceeds a threshold importance value, obtaining, from the selected group of precision levels, a highest precision level, and when the resources corresponding to the highest precision level are available, and the divergence exceeds a minimum divergence, running the quantum circuit on the resources corresponding to the highest precision level.

### TECHNOLOGICAL FIELD OF THE DISCLOSURE

Embodiments disclosed herein generally relate to quantum computing. More particularly, at least some embodiments relate to systems, hardware, software, computer-readable media, and methods, for predicting resources needed for simulation of a quantum circuit execution.

### BACKGROUND

When running ideal simulations, that is, tensor network based simulations of the execution of a quantum circuit, or a sub-circuit of a quantum circuit, on some classical infrastructure, the number of computational resources to be allocated may be predicted due to the known expected exponential complexity associated with circuit qubit count. When tensor networks are employed, however, there is no need to allocate as many resources. Nonetheless, the relationship between the desired tensor network precision and the number of resources to be allocated is not readily evident, making the estimation of the right number of resources a difficult problem.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an architecture, according to one embodiment.

FIG. 2 discloses aspects of a method, according to one embodiment.

FIG. 3 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to quantum computing. More particularly, at least some embodiments relate to systems, hardware, software, computer-readable media, and methods, for predicting resources needed for simulation of a quantum circuit execution.

One or more example embodiments comprise an architecture and/or method for predicting what resources will be needed for a tensor network (TN) simulation of the execution of a quantum circuit, where, in one embodiment, the quantum circuit comprises a quantum circuit obtained as a result of a quantum circuit cutting procedure performed on a ‘parent,’ or larger, quantum circuit. Such methods may comprise, for example, an offline procedure in which a dataset is created, and then used to train a model that is operable, given certain inputs, to determine the resources needed to support the tensor network simulation. In a subsequent, online, procedure, inputs are supplied to the model, and the model determines, based on the inputs, the resources needed for a given tensor network simulation. In an embodiment the determined resources comprise, or constitute, the minimum resources needed to perform the tensor network simulation, while still respecting one or more selected constraints.

One example dataset creation method may comprise operations including: creating a large set of random circuits with different respective numbers of qubits and depth; for each random circuit in the large set, simulating the circuit with a range of different precision values, using the highest precision value as ground truth for the circuit; collecting telemetry for each simulation, including information concerning resources consumed for the simulation; and, computing a divergence between the ground truth and a result of the simulation.

After this dataset has been created, it may be used to train a model, such as a machine learning (ML) model. An example ML training method may comprise performing a supervised learning procedure, and may train the ML model to estimate, for a given circuit, (1) required resources for supporting a TN simulation for that circuit, and (2) the divergence of that given circuit from the ground truth determined in the dataset creation phase.

During an online phase, the following operations may be performed: receiving, by the ML model, a circuit; based on a precision value for the circuit, determining an importance level for that circuit; for each different precision value for the circuit, computing the resources needed to perform a TN simulation of that circuit; evaluating an importance of the circuit, and using the importance to set a lowest possible precision for that circuit; attempting to run the circuit, using the computed resources; and, if the circuit cannot be run, notifying a user, else, when the importance of the circuit is greater than a specified threshold, looping over all the precision values for the circuit, and identifying the minimum resources needed to run the circuit.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may comprise a subcircuit orchestration method for circuit cutting procedures where TN-based simulations may be employed. An embodiment may comprise a resource allocation method that considers the precision of results associated with the use of TN-based simulations. An embodiment may comprise an ML model trained, and operable, to estimate resource consumption and fidelity of results associated with various precision levels of TNs and the importance of subcircuits.

### A. Aspects of an Example Context for One Embodiment

The following is a discussion of aspects of an example context for various embodiments. This discussion is not intended to limit the scope of the claims or this disclosure, or the applicability of the embodiments, in any way.

Tensor networks (TN) enable an approximate representation of quantum states and, as result, they can make simulations of quantum system of classical infrastructure more efficient. They offer mechanisms by which the dimensionality of matrices representing quantum operations and states can be reduced, therefore alleviating the exponential memory footprint of typical quantum simulations.

The dimensionality reduction enabled by a tensor network is governed by a real-valued precision parameter, alpha, in the range [0,1]. When α=1, the tensor-network based simulation of a quantum circuit is equivalent to an ‘ideal simulation’ with memory complexity of O(2\hat{ }N), where N is the number of qubits of the circuit. Here, the α value has the meaning of energy and is related to the sum of the eigenvalues extracted from the single value decomposition (SVD) algorithm internally used by the TN based simulation to compact the final matrix (or the latent space) of each stage of the network flow.

When running ideal simulations on some classical computing infrastructure, the number of computational resources to be allocated can be somewhat easily predicted due to the known expected exponential complexity associated with the qubit count of the circuit. When tensor networks are employed, however, there is no need to allocate as many resources. Nonetheless, it can be difficult to determine the relationship between the desired tensor network precision and the number of resources.

This problem presents itself in more sophisticated forms when circuit cutting is employed. As disclosed in https://arxiv.org/abs/2012.02333 “CutQC: Using Small Quantum Computers for Large Quantum Circuit Evaluations” by Wei Tang, Teague Tomesh, Martin Suchara, Jeffrey Larson, Margaret Martonosi (hereafter “CutQC”) (incorporated herein in its entirety by this reference), circuit cutting is an orchestration task when a large quantum circuit cannot run on a unique piece of quantum hardware, because quantum computers have limitations on the depth and number of qubits. This operation thus allows the execution of large circuits across different quantum architectures or even allowing the combination of quantum hardware and simulation engines.

When the subcircuits generated using the cutting procedure are executed on simulation engines, they can leverage tensor networks. However, the chosen precision of the network may adversely affect the quality of the of the end result, when the results of the subcircuits are knitted together.

Thus, an embodiment may address the problem of predicting the right type and amount of resources for some quantum circuit simulation using tensor networks in combination with circuit cutting procedures. One or more embodiments, which may be based on embodiments disclosed in U.S. patent application Ser. No. 18/926,102, titled “Efficient Approximation of a Circuit Knitting Scheme”, and filed Oct. 24, 2024 (hereafter, “Circuit Knitting”), may aid in determining which subcircuits derived from the cutting can be run with tensor networks, and at what level of precision. An embodiment may employ machine learning methods that learn the relationship between (1) resource consumption and (2) tensor-network precision conditioned on subcircuit characteristics. In an embodiment, resource predictions may then be used to identify the right classical computing infrastructure, that is, the minimum effective classical computing infrastructure, to execute a TN-based simulation of the subcircuits.

Thus, an embodiment may be able to estimate the resources needed to simulate a circuit using the tensor network (TN) approach, and the relation with the precision and final simulation result. As another example, an embodiment may not only generate a good resource prediction, but also perform an orchestration process to find a node, such as in a network comprising a group of n odes, that can run the TN based simulation, considering the resources that were identified as being required.

### B. Detailed Discussion of Aspects of One or More Embodiments

As indicated earlier herein, an embodiment may comprise an offline phase, followed by an online phase. Each of the offline phase and the online phase may comprise one or more respective methods, each involving various operations. For example, an embodiment may comprise an offline phase that includes a dataset creation process, and an ML model training process. An online phase, which may be performed after the offline phase is completed, may comprise making, and carrying out, an orchestration decision in which a TN-based simulation of a quantum circuit execution is orchestrated to a particular node, or possibly a group of nodes, of a network, for execution.

### B.1 Dataset Creation

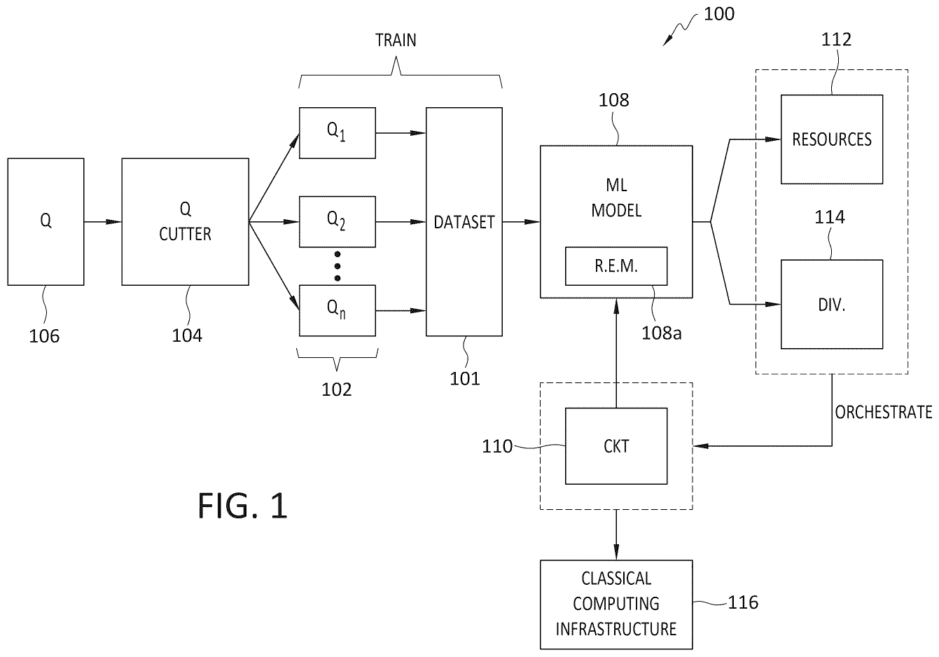

With reference now to the example architecture 100 of FIG. 1, a dataset 101 creation process may begin with the creation of a large set of random circuits c 102, possibly generated using a circuit cutter 104 to cut a circuit 106, and each of the random circuits c 102having a different respective number of qubits and depth. The size of the circuits may consider the limitations imposed by the classical computing infrastructure where the execution of the circuits is to be simulated.

Next, for each random circuit c, simulate that circuit c using a TN simulation method with different values of precision α. To illustrate, in an embodiment, higher precision values of α may be 0.99, 0.95, 0.9 and 0.85, while a lower precision value of α might be 0.6. In an embodiment, the highest precision value, which is 0.99 in the preceding example, of the TN simulation may be used as the ground truth result for the circuit c. As used herein, the ‘precision’ of a quantum circuit simulation refers to the accuracy with which that simulation reproduces the behavior, or expected behavior, of a real quantum circuit. Thus, a ‘divergence’ may be an extent to which the behavior of the circuit in the simulation deviates from the behavior of a real quantum circuit having the same configuration as the circuit in the simulation.

Another approach may be to compute the state vector simulation, that is, without tensor networks, of the circuit c in order to obtain the ground truth result for the simulation but depend on circumstances such as the number of qubits of the circuit. this method may become prohibitive in terms of time and/or computing resources needed.

Finally, telemetry may be collected for each circuit c simulation using TN and, as well, information indicating the amount and/or type of resources r consumed by the simulation of the circuit c may be collected. The resources may be, for example, the memory, such as GPU or system, needed for the simulation, and the amount of time taken to perform the simulation. As well, an embodiment may compute a divergence measurement d, that is, a fidelity, between the TN0-based simulation result, and the ground truth. As noted above, the ground truth may be expressed in terms of the precision of the simulation of the quantum circuit c.

### B.2 ML Model Training

After the dataset 101, which may be referred to as a training dataset, has been created, an ML model 108 may then be trained using the dataset 101. For example, in an embodiment, a labeled dataset 101 composed by x=(c, α) and y=(r, d) can be used to train a machine learning model M. The trained machine learning model M 108 may estimate, for a given circuit (c′) and precision (α′), the (1) required resources for simulating execution of the circuit, and (2) the divergence of that circuit from the ground truth. In an embodiment, the ML training procedure may comprise performing a supervised learning procedure. One example embodiment for the training procedure may use a directed acyclic graph (DAG) representation for each circuit c as an input to the ML model 108. In this example at least, there is no need to preprocess the alpha values since those values may be scaled between 0 and 1, inclusive.

### B.3 Orchestration Decision

With the trained ML model in hand, resource estimation, and divergence calculation, can be performed by the ML model 108 for a circuit. By way of overview, a resource estimation module 108a of the trained ML model 108 may receive the circuit 110. The ML model may use the circuit to generation a pair of outputs, namely, the resources 112 needed to perform a simulation of the circuit 110, and the divergence 114 of the simulation of the circuit. These outputs may be used to inform an orchestration decision, possibly by the ML model 108, to orchestrate the circuit 110 to a classical computing infrastructure 116.

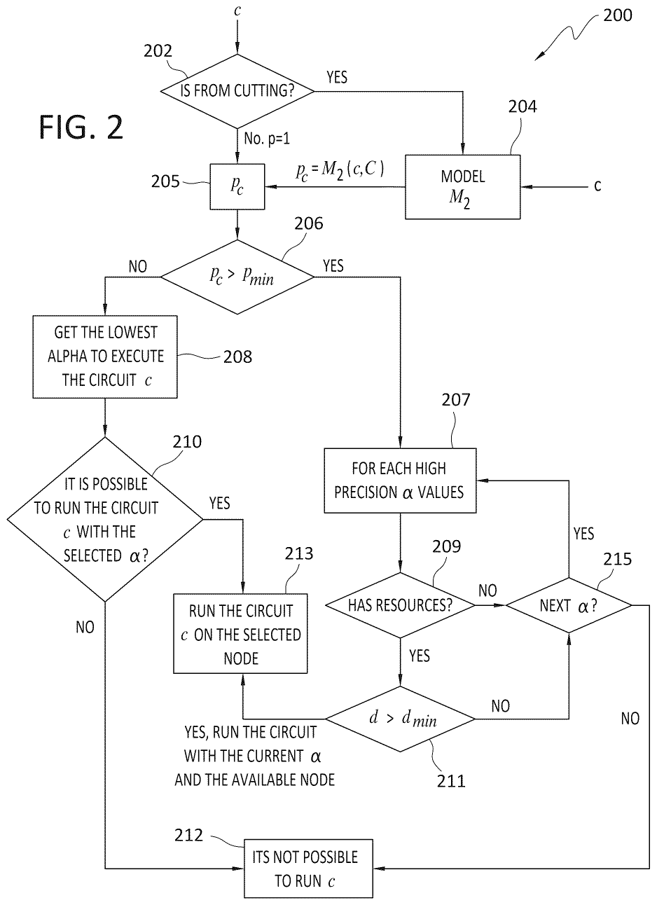

In more detail, and with reference now to FIG. 2, an example method 200 for an orchestration decision is disclosed in FIG. 2. The method 200 may begin when a circuit c may is sent to a resource estimation module (REM) of an ML model. A check 202 may be performed to determine if the circuit c originated from a cutting procedure using a circuit C. If so, the model M2 specified in “Circuit Knitting” may be used to estimate 204 the importance pc that the circuit c has in a final knitting probability result.

It is noted that, in an embodiment, there is a direct proportional

relation between α and the importance p for a circuit—for example, if p is lower, an embodiment may decrease the precision of the simulation α in order to save resources since the probability will not significantly affect the outcome(s) of the final simulation(s)—such that it is possible to estimate the α for a circuit as function of p: α=f(p). Otherwise, and as shown in FIG. 2, the importance will be set 205 at a maximum such that (p=p_{c}=1), and α should be as close to 1 as possible. For each alpha (αᵢ) value, given the set of various α values specified to be used for the circuit c, compute the output of the model M using (1) the circuit c and (2) the current α, as input: (rᵢ, dᵢ)=M(c, αᵢ)∀αᵢ.

Next, the method 200 advances and an evaluation 206 is performed in which the importance p_{c} of the circuit c is compared against a predefined importance threshold thus (p_{c}<pₘᵢₙ), where the predefined importance threshold may be specified by a user as a condition of an SLA (service level agreement), for example. Next, set 208 the lowest α value possible, such as 0.6 in the illustrative example noted in the discussion of dataset creation above, to gather the resources to simulate the circuit. An attempt may then be made to run the circuit with the selected lowest α value. If it is determined 210 that the circuit cannot be run with the identified resources, then return a message 212 to the user indicating that it was not possible to run that circuit. On the other hand, if it is determined 206 that p_{c}≥pₘᵢₙ, then loop over all possible high precision αᵢ values in a descending order—such as 0.99, 0.95, 0.9 and 0.85 in the example noted above—to find the minimum resource needed to run the circuit c. If any αᵢ can be used to simulate the circuit then, return to user a message 212 saying that it was not possible to run the circuit c.

In more detail, and with continued reference to the example of FIG. 2, the method 200 may perform 207 various operations for each high precision αᵢ value, beginning with checking 209 to determine if resources are available at one or more nodes to run the circuit. If so, and if the divergence d is determined 211 to be greater than a minimum divergence dₘᵢₙ, the circuit is run 213 with the current value of α on a selected node. Similarly, if it is determined 210 that the circuit can be run with the selected value of α, the circuit is run 213 with that value of α on a selected node.

On the other hand, if the divergence d is determined 211 to not be greater than a minimum divergence dₘᵢₙ, then the method 200 may advance to 215 to determine if a next lower value of α remains and, if so, the method 200 may return to 207. Likewise, if the check 209 indicates that a node does not have the resources needed to run the circuit, given the value of α, the method may advance to 215 to determine if a next lower value of α remains and, if so, the method 200 may return to 207.

### B.4 Further Discussion

As disclosed herein, one or more embodiments may possess various useful features and aspects, although no embodiment is required to possess any of such features or aspects. The following examples are illustrative, but not exhaustive.

An embodiment may comprise a subcircuit orchestration method for circuit cutting procedures where TN-based simulations may be employed. An embodiment may comprise a resource allocation method that considers the precision of results associated with the use of TN-based simulations. An embodiment may comprise a machine learning model to estimate resource consumption and fidelity of results associated with various precision levels of TNs and the importance of subcircuits. By way of contrast with one or more example embodiments, the inventors are presently unaware of any orchestration mechanism for circuit cutting that employs resource prediction based on TN-based simulations of subcircuits.

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### D. Further Example Embodiments

Following are some further example embodiments. These are presented only by way of example and are not intended to limit the scope of this disclosure or the claims in any way.

Embodiment 1. A method, comprising: receiving, by an ML (machine learning) model, a quantum circuit; obtaining an importance value of the quantum circuit; for each precision level in a group of precision levels, determining, by the ML model, resources required to run the quantum circuit, and a divergence of the circuit; when the importance value exceeds a threshold importance value, obtaining, from the group of precision levels, a highest precision level; and when the resources corresponding to the highest precision level are available, and the divergence exceeds a minimum divergence, running the quantum circuit on the resources corresponding to the highest precision level.

Embodiment 2. The method as recited in any preceding embodiment, wherein the ML model was trained using a dataset comprising, for each random circuit in a group of random circuits, (1) information concerning a TN-based simulation of the random circuit, (2) an identification of resources consumed the by the TN-based simulation of the random circuit, and (3) a divergence between the TN-based simulation of the random circuit and a ground truth for that random circuit.

Embodiment 3. The method as recited in any preceding embodiment, wherein the divergence comprises an extent to which a behavior of the circuit in a TN (tensor network)-based simulation deviates from behavior of a real quantum circuit having a same configuration as the circuit.

Embodiment 4. The method as recited in any preceding embodiment, wherein when the importance value does not exceed the threshold importance value: obtaining, from the selected group of precision levels, a lowest precision level; determining whether or not it is possible to run the quantum circuit on the resources corresponding to the lowest precision level; and when it is not possible to run the quantum circuit on the resources corresponding to the lowest precision level, transmitting a corresponding message to a user; and when it is possible to run the quantum circuit on the resources corresponding to the lowest precision level, running the quantum circuit on a network node that possesses the resources.

Embodiment 5. The method as recited in any preceding embodiment, wherein when the resources corresponding to the highest precision level are not available, and there is a next lower precision level in the group of precision levels, a check is performed to determine if the resources corresponding to the next lower precision level are available and, if so, and the divergence exceeds the minimum divergence, running the quantum circuit on the resources corresponding to the next lower precision level.

Embodiment 6. The method as recited in embodiment 5, wherein when there is no next lower precision level in the group of precision levels, transmitting a message to a user that the quantum circuit cannot be run.

Embodiment 7. The method as recited in any preceding embodiment, wherein the importance value indicates an extent to which the quantum circuit is expected to influence performance of a final quantum circuit that comprises the quantum circuit, as a subcircuit, knitted together with one or more other subcircuits.

Embodiment 8. The method as recited in any preceding embodiment, wherein the quantum circuit is a subcircuit that was cut from a larger quantum circuit, and another ML model is used to estimate the importance value of the quantum circuit.

Embodiment 9. The method as recited in any preceding embodiment, wherein the resources comprise a classical computing infrastructure.

Embodiment 10. The method as recited in any preceding embodiment, wherein the quantum circuit is run on the minimum resources possible.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

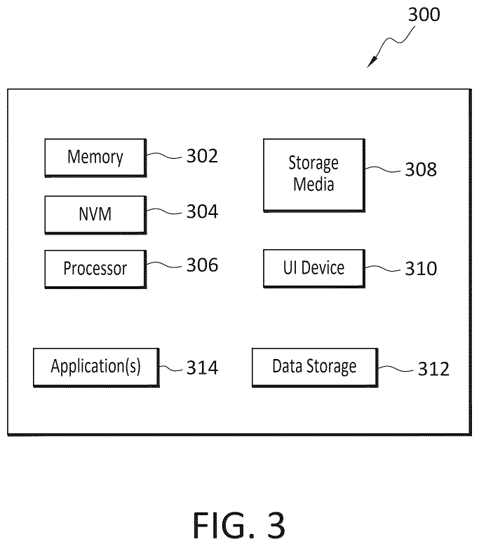

With reference briefly now to FIG. 3, any one or more of the entities disclosed, or implied, by FIGS. 1-2, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 306 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving, by an ML (machine learning) model, a quantum circuit;
obtaining an importance value of the quantum circuit;
for each precision level in a group of precision levels, determining, by the ML model, resources required to run the quantum circuit, and a divergence of the circuit;
when the importance value exceeds a threshold importance value, obtaining, from the group of precision levels, a highest precision level; and
when the resources corresponding to the highest precision level are available, and the divergence exceeds a minimum divergence, running the quantum circuit on the resources corresponding to the highest precision level.

2. The method as recited in claim 1, wherein the ML model was trained using a dataset comprising, for each random circuit in a group of random circuits, (1) information concerning a TN-based simulation of the random circuit, (2) an identification of resources consumed the by the TN-based simulation of the random circuit, and (3) a divergence between the TN-based simulation of the random circuit and a ground truth for that random circuit.

3. The method as recited in claim 1, wherein the divergence comprises an extent to which a behavior of the circuit in a TN (tensor network)-based simulation deviates from behavior of a real quantum circuit having a same configuration as the circuit.

4. The method as recited in claim 1, wherein when the importance value does not exceed the threshold importance value:
obtaining, from the selected group of precision levels, a lowest precision level; determining whether or not it is possible to run the quantum circuit on the resources corresponding to the lowest precision level; and
when it is not possible to run the quantum circuit on the resources corresponding to the lowest precision level, transmitting a corresponding message to a user; and
when it is possible to run the quantum circuit on the resources corresponding to the lowest precision level, running the quantum circuit on a network node that possesses the resources.

5. The method as recited in claim 1, wherein when the resources corresponding to the highest precision level are not available, and there is a next lower precision level in the group of precision levels, a check is performed to determine if the resources corresponding to the next lower precision level are available and, if so, and the divergence exceeds the minimum divergence, running the quantum circuit on the resources corresponding to the next lower precision level.

6. The method as recited in claim 5, wherein when there is no next lower precision level in the group of precision levels, transmitting a message to a user that the quantum circuit cannot be run.

7. The method as recited in claim 1, wherein the importance value indicates an extent to which the quantum circuit is expected to influence performance of a final quantum circuit that comprises the quantum circuit, as a subcircuit, knitted together with one or more other subcircuits.

8. The method as recited in claim 1, wherein the quantum circuit is a subcircuit that was cut from a larger quantum circuit, and another ML model is used to estimate the importance value of the quantum circuit.

9. The method as recited in claim 1, wherein the resources comprise a classical computing infrastructure.

10. The method as recited in claim 1, wherein the quantum circuit is run on the minimum resources possible.

11. A non-transitory storage medium having stored therein instructions that are executable by one or more hardware processors to perform operations comprising:
receiving, by an ML (machine learning) model, a quantum circuit;
obtaining an importance value of the quantum circuit;
for each precision level in a group of precision levels, determining, by the ML model, resources required to run the quantum circuit, and a divergence of the circuit;
when the importance value exceeds a threshold importance value, obtaining, from the group of precision levels, a highest precision level; and
when the resources corresponding to the highest precision level are available, and the divergence exceeds a minimum divergence, running the quantum circuit on the resources corresponding to the highest precision level.

12. The non-transitory storage medium as recited in claim 11, wherein the ML model was trained using a dataset comprising, for each random circuit in a group of random circuits, (1) information concerning a TN-based simulation of the random circuit, (2) an identification of resources consumed the by the TN-based simulation of the random circuit, and (3) a divergence between the TN-based simulation of the random circuit and a ground truth for that random circuit.

13. The non-transitory storage medium as recited in claim 11, wherein the divergence comprises an extent to which a behavior of the circuit in a TN (tensor network)-based simulation deviates from behavior of a real quantum circuit having a same configuration as the circuit.

14. The non-transitory storage medium as recited in claim 11, wherein when the importance value does not exceed the threshold importance value:
obtaining, from the selected group of precision levels, a lowest precision level; determining whether or not it is possible to run the quantum circuit on the resources corresponding to the lowest precision level; and
when it is not possible to run the quantum circuit on the resources corresponding to the lowest precision level, transmitting a corresponding message to a user; and
when it is possible to run the quantum circuit on the resources corresponding to the lowest precision level, running the quantum circuit on a network node that possesses the resources.

15. The non-transitory storage medium as recited in claim 11, wherein when the resources corresponding to the highest precision level are not available, and there is a next lower precision level in the group of precision levels, a check is performed to determine if the resources corresponding to the next lower precision level are available and, if so, and the divergence exceeds the minimum divergence, running the quantum circuit on the resources corresponding to the next lower precision level.

16. The non-transitory storage medium as recited in claim 15, wherein when there is no next lower precision level in the group of precision levels, transmitting a message to a user that the quantum circuit cannot be run.

17. The non-transitory storage medium as recited in claim 11, wherein the importance value indicates an extent to which the quantum circuit is expected to influence performance of a final quantum circuit that comprises the quantum circuit, as a subcircuit, knitted together with one or more other subcircuits.

18. The non-transitory storage medium as recited in claim 11, wherein the quantum circuit is a subcircuit that was cut from a larger quantum circuit, and another ML model is used to estimate the importance value of the quantum circuit.

19. The non-transitory storage medium as recited in claim 11, wherein the resources comprise a classical computing infrastructure.

20. The non-transitory storage medium as recited in claim 11, wherein the quantum circuit is run on the minimum resources possible.
